(19) United States
(12) Patent Application Publication
(10) Pub. No.: US 2008/0013017 A1
(43) Pub. Date: Jan. 17, 2008

(54) LIQUID CRYSTAL DISPLAY

(75) Inventors: Yoshimitsu ISHIKAWA, Tokyo (JP); Shingo NAGANO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/767,099

(22) Filed: Jun. 22, 2007

(30) Foreign Application Priority Data
Jun. 30, 2006 (JP) 2006-182689

(51) Int. Cl. G02F 1/1335

(52) U.S. Cl. 349/98

(57) ABSTRACT

A liquid crystal display device according to an embodiment of the present invention is a horizontal electric field type liquid crystal display. In the device, a liquid crystal layer is sandwiched between a first substrate and a second substrate opposite to each other, pixels arranged in matrix include a transmissive region and a reflective region, and the first substrate include a pixel electrode and a common electrode for applying a voltage to the liquid crystal layer. An about-λ/2-wave plate, an about-λ/4-wave plate, and a polarizing plate are provided opposite to the liquid crystal layer in the first substrate in this order from the first substrate side. An about-λ/4-wave plate and a polarizing plate are provided opposite to the liquid crystal layer in the second substrate in this order from the second substrate side.

### BACKGROUND OF THE INVENTION

1. Field of the Invention

The present invention belongs to the field of liquid crystal display. In particular, the invention relates to a transflective liquid crystal display.

2. Description of Related Art

Liquid crystal displays are roughly classified into three display types of a transmissive type, a reflective type, and a transflective type. A transmissive type display turns on light called “back light” to display an image by use of light transmitted through the liquid crystal display and thus has high scotopic visibility but has low photopic visibility. On the other hand, a reflective type display displays an image by use of light incident on and reflected by the liquid crystal display and thus has high photopic visibility but has low scotopic visibility. A so-called transflective type display having both functions of the transmissive type and reflective type switches a display mode in accordance with ambient brightness to thereby realize a display of high visibility all the time. Thus, the transflective liquid crystal display has been widely used for a cell-phone or mobile-device display.

In particular, in a transflective liquid crystal display including a region where an image is displayed in a transmissive mode (transmissive region) and a region where an image is displayed in a reflective mode (reflective region), which are separately formed in one pixel, circularly polarizing plates are arranged on both sides of a panel, and a liquid crystal layer thickness is set for each of the reflective region and the transmissive region such that the product of the liquid crystal layer thickness of the reflective region and liquid-crystal refractive index anisotropy (Δn) equals about ¼-wavelength, and the product of the liquid crystal layer thickness of the transmissive region and liquid crystal refractive index anisotropy (Δn) equals about ½-wavelength. Thus, either in the reflective mode or transmissive mode, an image can be displayed in a normally white mode (display mode for applying a voltage to the liquid crystal layer to turn a screen black), and comparatively high display characteristics can be obtained.

In general, the circularly polarizing plate is completed by combining a polarizing plate, a ¼-wavelength plate (λ/4-wave plate, quarter wave plate), and a ½-wavelength plate (λ/2-wave plate, half wave plate). Optical characteristics thereof include wavelength dependency (wavelength dispersion). The wavelength dispersion is controlled by appropriately selecting a combination thereof to thereby obtain high display characteristics as viewed from the front.

Similar to a TN (Twisted Nematic) type liquid crystal display used for the conventional transmissive type liquid crystal display, existing transflective liquid crystal displays apply a voltage to twisted liquid crystal or parallel-aligned liquid crystal in the substrate normal direction to turn on/off light (switching). According to this method, liquid crystal molecules oriented in parallel to the substrate if not applied with a voltage are realigned toward the direction of electric field when applied with a voltage, that is, the substrate normal direction.

In the direction where the liquid crystal molecules are realigned, there is an angle at which a liquid crystal phase difference is 0 as observed at a given angle, tone reversal occurs. The term “tone reversal” means a phenomenon that light and dark image portions are inverted. A visibility of a displayed image is considerably lowered when the tone reversal occurs. These transflective liquid crystal displays of the related art are inferior in visibility to a transmissive liquid crystal display in other than the front field of view.

To solve the problem that tone reversal occurs in the transflective liquid crystal display, there is a technique of using a VA mode (Vertical Alignment), an IPS mode (In-Plane Switching), or a FFS mode (Fringe Field Switching) free of tone reversal, for a transflective display. For example, a technique disclosed in Japanese Unexamined Patent Application Publication No. 2003-57674 relates to the VA mode of a transflective display; this technique divides both of a transmissive region and a reflective region into plural pixel regions to suppress tone reversal.

In contrast, for example, Japanese Unexamined Patent Application Publication No. HEI11-242226, Japanese Unexamined Patent Application Publication No. 2003-344837, Japanese Unexamined Patent Application Publication No. 2005-106967, and T. B. Jung and S. H. Lee “A Novel Transflective Display Associated with Fringe-Field Switching” SID03 DIGEST (pp. 592-595) (hereinafter referred to as T. B. Jung et al.) disclose the following technique. In a horizontal electric field type transflective liquid crystal display for driving liquid crystal molecules in a plane parallel to a substrate such as the IPS mode or FFS mode, it is unnecessary to provide a complicated dielectric protrusion that is indispensable for dividing into pixels in the VA mode. A black-and-white display can be obtained both in the transmissive mode and the reflective mode without involving tone reversal only by adding a retarder such as a λ/4-wave plate, a λ/2-wave plate, or a biaxial retarder to a transmissive liquid crystal display.

However, to divide an orientation region with the technique of Japanese Unexamined Patent Application Publication No. 2003-57674, it is necessary to add a complicated dielectric protrusion for controlling the orientation of liquid crystal molecules, resulting in an increase in manufacturing cost. Further, the display devices of Japanese Unexamined Patent Application Publication Nos. HEI11-242226 and 2003-344837 enable only black-and-white display in both of a transmissive mode and a reflective mode with the IPS mode, and so cannot attain wide view angle as a feature of the IPS. The display device of T. B. Jung et al. only enables a black-and-white display in both of a transmissive mode and a reflective mode with the FFS mode, and so cannot reach the level of a display device of wide view angle. The display device of Japanese Unexamined Patent Application Publication No. 2005-106967 enables a black-and-white display in both of a transmissive mode and a reflective mode with a wide view angle, but its device configuration is limited.

### SUMMARY OF THE INVENTION

In view of the foregoing, it is an object of the present invention to provide a liquid crystal display of novel structure with high display characteristics.

A horizontal electric field type liquid crystal display according to an aspect of the present invention includes: a first substrate; a second substrate opposite to the first substrate; a liquid crystal layer sandwiched between the first substrate and the second substrate; pixels arranged in matrix and including a transmissive region and a reflective region; a pixel electrode and a common electrode provided on the first substrate and applying a voltage to the liquid crystal layer; a first about-λ/2-wave plate provided on the opposite side of the liquid crystal layer in the first substrate; a first about-λ/4-wave plate provided on the opposite side of the liquid crystal layer in the first about-λ/2-wave plate; a first polarizing plate provided on the opposite side of the liquid crystal layer in the first about-λ/4-wave plate; a second about-λ/4-wave plate provided on the opposite side of the liquid crystal layer in the second substrate; and a second polarizing plate provided on the opposite side of the liquid crystal layer in the second about-λ/4-wave plate.

Thus, it is possible to provide a liquid crystal display capable of realizing wide view angle.

A horizontal electric field type liquid crystal display according to another aspect of the present invention includes: a first substrate; a second substrate opposite to the first substrate; a liquid crystal layer sandwiched between the first substrate and the second substrate; pixels arranged in matrix and including a transmissive region and a reflective region; a pixel electrode and a common electrode provided on the first substrate and applying a voltage to the liquid crystal layer; a first about-λ/2-wave plate provided on the opposite side of the liquid crystal layer in the first substrate; a second about-λ/2-wave plate provided on the opposite side of the liquid crystal layer in the first about-λ/2-wave plate; a first about-λ/4-wave plate provided on the opposite side of the liquid crystal layer in the second about-λ/2-wave plate; a first polarizing plate provided on the opposite side of the liquid crystal layer in the first about-λ/4-wave plate; a third about-λ/2-wave plate provided on the opposite side of the liquid crystal layer in the second substrate; a second about-λ/4-wave plate provided on the opposite side of the liquid crystal layer in the third about-λ/2-wave plate; and a second polarizing plate provided on the opposite side of the liquid crystal layer in the second about-λ/4-wave plate.

Thus, it is possible to provide a liquid crystal display capable of realizing wide view angle.

According to the liquid crystal display of the present invention, it is possible to provide a liquid crystal display capable of transmissive display at wide view angle and black-and-white display in both of the transmissive mode and the reflective mode without involving tone reversal at low cost.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a sectional view of a liquid crystal panel according to the present invention;

FIG. 2 is a plan view of a TFT substrate according to the present invention;

FIG. 3 is a plan view of a CF substrate according to the present invention;

FIG. 4 is a sectional view of a liquid crystal panel for demonstrating a liquid crystal state under such conditions that no voltage is applied in an FFS mode;

FIG. 5 is a sectional view of a liquid crystal panel for demonstrating a liquid crystal state under such conditions that a voltage is applied in an FFS mode;

FIG. 6 is a sectional view of a liquid crystal display according to a first embodiment of the present invention;

FIG. 7 shows calculated values on an iso CR curve in a transmissive mode according to the first embodiment;

FIG. 8 shows actual measurement values on an iso CR curve in a transmissive mode according to the first embodiment;

FIG. 9 is a sectional view of a liquid crystal display according to a second embodiment of the present invention; and

FIG. 10 shows calculated values on an iso CR curve in a transmissive mode according to the second embodiment.

### DESCRIPTION OF THE PREFERRED EMBODIMENTS

Prior to description of the embodiments, common structure, method, etc., that is, structure and fabrication method of a liquid crystal panel, and movement of liquid crystal molecules of a liquid crystal panel are described. Here, according to the present invention, a transmissive region involves a phase difference of about λ/2 if a liquid crystal layer is not applied with a voltage, and a reflective region involves a phase difference of about λ/4 if a liquid crystal layer is not applied with a voltage. Further, the present invention is applicable to all liquid crystal modes that allow application of horizontal electric field to liquid crystal (for example, an IPS mode or an FFS mode). The following description about the structure and fabrication method of a liquid crystal panel and movement of liquid crystal molecules is given based on an array structure of the FFS mode.

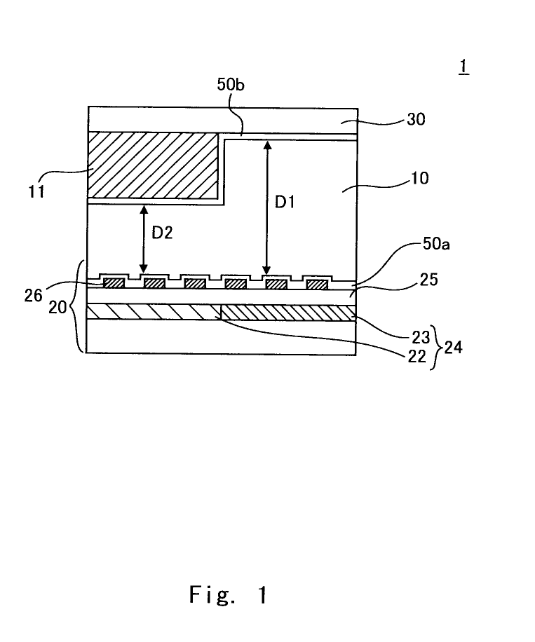

FIG. 1 is a sectional view of a liquid crystal panel 1 in a transflective liquid crystal display to which the present invention is applied. As shown in FIG. 1, a liquid crystal layer 10 in the liquid crystal panel 1 is sandwiched between a TFT substrate 20 including thin film transistors (TFTs) and a CF substrate 30 including a color filter (CF). In each pixel of the TFT substrate 20, a transmissive electrode (transparent electrode) 22 corresponding to a transmissive region and a reflective electrode 23 corresponding to a reflective region are formed.

A region including the transmissive electrode 22 (transmissive region) transmits light from a backlight source and a region including the reflective electrode 23 (reflective region) reflects external light. Then, the transmissive electrode 22 and the reflective electrode 23 constitute a common electrode 24. Further, a protective film 25 is formed to cover the common electrode 24. Further, a comb-like pixel electrode 26 is formed on the common electrode 24 through a protective film 25 as an insulating film. A driving voltage for driving a liquid crystal is applied to the pixel electrode 26 through a TFT (not shown).

Further, an oriented film 50a is formed between the TFT substrate 20 and the liquid crystal layer 10. Further, an oriented film 50b is formed between the CF substrate 30 and the liquid crystal layer 10. The oriented film 50 is a film for aligning liquid crystal molecules in the liquid crystal layer 10. This film is subjected to rubbing to thereby align liquid crystal molecules in a predetermined direction.

In the transflective liquid crystal display of the present invention, a cell gap should be set in each of the transmissive region and the reflective region. To define a cell gap in each region, a gap control layer 11 is formed on the CF substrate 30 side of the liquid crystal layer 10. Further, the gap control layer 11 is formed opposite to the reflective electrode 23. The gap control layer 11 controls a phase difference in the reflective region and the transmissive region.

According to the present invention, a phase difference of the liquid crystal layer 10 of the reflective region is about λ/4 if the liquid crystal layer 10 is not applied with a voltage, and a phase difference of the liquid crystal layer 10 of the transmissive region is about λ/2 if the liquid crystal layer 10 is not applied with a voltage. Incidentally, the gap control layer 11 may be formed on the TFT substrate 20 side as well as the CF substrate 30 side of the liquid crystal layer 10 as shown in FIG. 1.

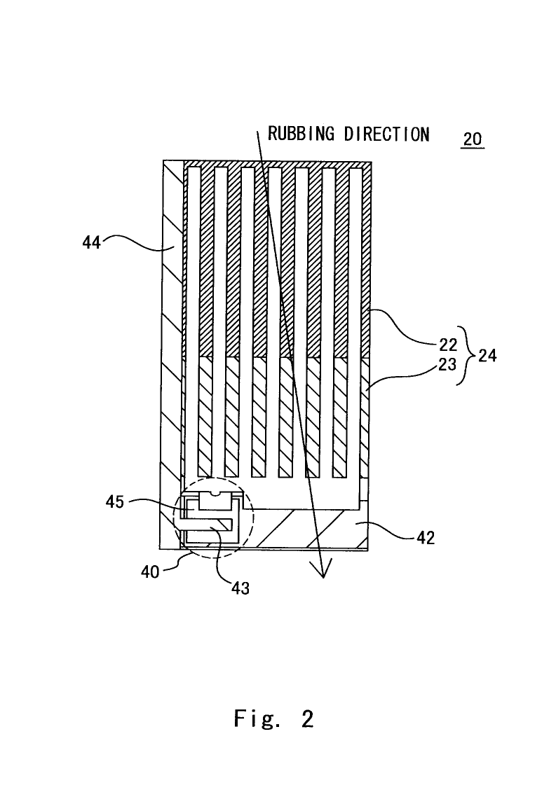

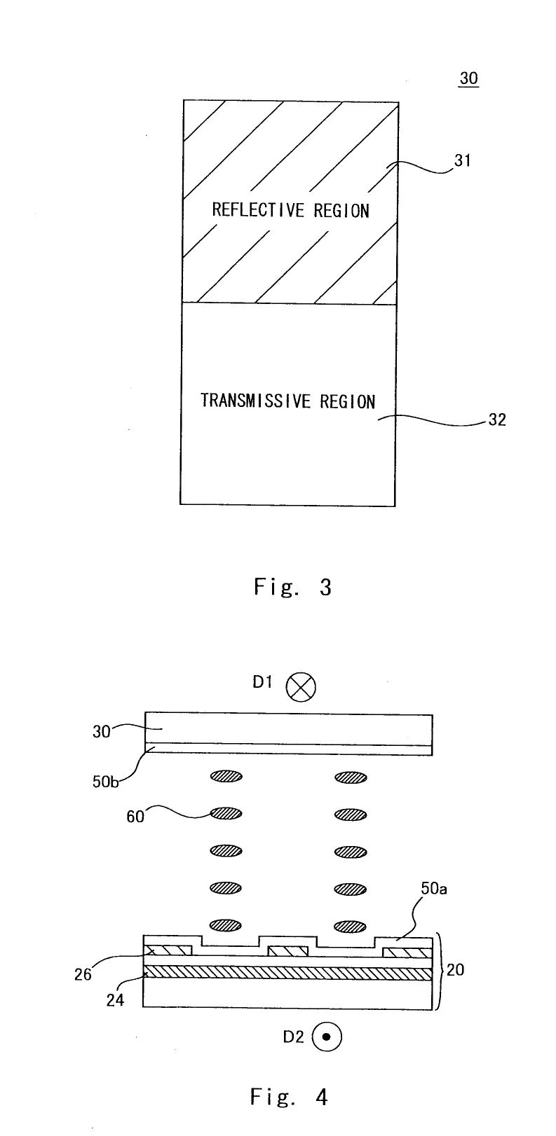

FIG. 2 is a plan view of the TFT substrate 20 of the present invention, and FIG. 3 is a plan view of the CF substrate 30. In both of the transmissive region and the reflective region of each pixel of the TFT substrate 20, the comb-like pixel electrode 26 for forming the liquid crystal is formed, and the common electrode 24 is formed below the pixel electrode 26. Further, the common electrode 24 of all pixels is connected with a common line.

Further, the TFT 40 is provided in each pixel. The TFT 40 is electrically connected with the pixel electrode 26. A gate electrode (not shown) of the TFT 40 is formed on a gate line (scanning line) 42. The ON/OFF control over the TFT is executed in accordance with a signal input from a gate terminal. A source electrode 43 of the TFT 40 is connected with a source line (signal line) 44. Further, a drain electrode 45 of the TFT 40 is connected with the pixel electrode 26.

If a voltage is applied to the gate electrode of the TFT 40, a current flows through the source line 44. Further, a level of voltage applied to the source electrode 43 is controlled as desired to thereby change an actual voltage applied to the liquid crystal (driving voltage). A voltage applied to the liquid crystal can be controlled with the source electrode 43. Thus, as for driving conditions of the liquid crystal, intermediate transmittance of the liquid crystal can be freely set.

The above pixels are arranged in matrix in a display region on the TFT substrate 20. Therefore, plural gate lines 42 extend in parallel. Further, plural source lines 44 extend in parallel. A region surrounded by two adjacent gate lines 42 and two adjacent source lines 44 corresponds to a pixel. Further, in the TFT 40, a semiconductor thin film is formed on the gate insulating film. The semiconductor thin film includes a source region connected with the source electrode 43, a drain region connected with the drain electrode 45, and a channel region formed between the source region and the drain region.

Further, the CF substrate 30 is divided into two regions: a reflective region 31 and a transmissive region 32. That is, transmissive region 32 of the CF substrate 30 is formed on the transmissive region of the TFT substrate 20 as a region including the transmissive electrode 22. The reflective region 31 of the CF substrate is formed on the reflective region of the TFT substrate 20 as a region including the reflective electrode 23 and the gap control layer 11. Incidentally, the present invention is not only applied to such simple structure that the transmissive region and the reflective region are upper and lower regions of a pixel as shown in FIGS. 2 and 3 but also the structure where the transmissive region and the reflective region are arbitrarily defined.

Referring next to FIGS. 1 and 2, a process of forming the TFT substrate 20 is described. First, a transparent electrode is used to form the transmissive electrode 22. To be specific, a transparent conductive film made of ITO (Indium Tin Oxide), SnO₂, InZnO, or the like, a laminate thereof, or a transparent conductive layer of a mixture thereof is formed through sputtering, evaporation, coating, CVD, printing, and a sol-gel method, and the transmissive electrode 22 is formed through a photoengraving process and an etching process. The transmissive electrode 22 is formed at least in the transmissive region.

Subsequently, the gate line 21, the gate electrode of the TFT 40, the gate terminal, the common line, and the reflective electrode 23 as a reflector are formed. First, a metal film is formed on the substrate through sputtering, followed by a photoengraving process for applying a resist as a photosensitive resin through spin coast, and performing exposure and development thereof. After that, patterning is executed through etching to thereby form the gate line 42, the gate electrode of the TFT 40, the gate terminal, the common line, and the reflective electrode 23. The reflective electrode 23 is formed only in the reflective region.

Here, the transmissive electrode 22 and the reflective electrode 23 partially overlap with each other. As a result, the transmissive electrode 22 and the reflective electrode 23 are brought into contact with each other and electrically connected together. Further, the common line is integrally formed with the reflective electrode 23. Further, the common line is formed in parallel to the gate line 42 between adjacent gate lines 42 to connect common electrodes of adjacent pixels. Therefore, a common potential is applied to the transmissive electrode 22 and the reflective electrode 23 that constitute the common electrode 24 through the common line.

Next, an amorphous silicon film as a semiconductor thin film and a gate insulating film are formed by various CVD methods such as a plasma CVD method, and a pattern of the semiconductor thin film is formed through a photoengraving process and an etching process. In this case, a contact hole for short-circuiting the common line to the source line 44 outside a display region is formed in the gate insulating film on the common line. Further, the gate insulating film may be formed to cover the common electrode 24 or not to cover the common electrode 24. After that, a conductive film for forming a source line is formed through sputtering. Then, the source line 44, the source electrode 43, the drain electrode 45, and the source terminal are formed through photoengraving process and etching process. Further, a conductive pattern for short-circuiting plural common lines is formed on the contact hole.

It is desirable that the patterns of the source line 44, the source electrode 43, the drain electrode 45, and the source terminal be used as a mask to remove the underlying semiconductor thin film through etching to insulate the adjacent source lines 44 from each other. After that, an insulating film is formed of Si₃N₄, SiO₂, or a mixture or laminate thereof through various CVD methods such as plasma CVD to thereby form the protective film 25.

To electrically connect between the gate terminal and the source terminal, a contact hole is formed in the gate insulating film and the protective film 25. At this time, to establish continuity with the drain electrode 45 of the TFT 40, a contact hole is also formed in the protective film 25 on the drain electrode 45. After that, a transparent conductive film of ITO, SnO₂, InZnO, or the like, a laminate thereof, or a transparent conductive layer of mixture thereof is formed through sputtering, evaporation, coating, CVD, printing, and sol-gel method. The comb-like pixel electrode 26 is formed through photoengraving process and etching process. The pixel electrode 26 is electrically connected with the drain electrode 45 of the TFT 40 through the contact hole. Therefore, a driving voltage for driving a liquid crystal is applied to the pixel electrode 26 through the source line 44. Incidentally, a potential may be applied in a reverse direction. That is, a common potential may be applied to the comb-like electrode, and a pixel potential may be applied to a lower layer. In this case, the comb-like electrode is connected with the common line.

Next, an assembly process of the liquid crystal panel 1 composed of the thus-manufactured TFT substrate 20 and opposite CF substrate 30 is described. The two substrates are coated with a polyimide resin, for example, JALS-3003 available from JSR as an oriented film 50 for aligning liquid crystal molecules, followed by rubbing with cloth. The liquid crystal is parallel-aligned. As the rubbing direction of the TFT substrate 20 and the CF substrate 30, there are a parallel direction and a non-parallel direction. In this example, the rubbing direction is a non-parallel direction.

In the transmissive region of the liquid crystal panel 1 of the present invention, if no voltage is applied between the pixel electrode 26 and the common electrode 24, liquid crystal molecules are uniaxial-oriented in the direction substantially vertical to the figure plane. In this case, however, if a voltage is applied between the pixel electrode 26 and the common electrode 24, an electric field is generated in the liquid crystal layer 10, torsional deformation of the liquid crystal molecules occurs. To control the direction of torsional deformation accompanying voltage application, the rubbing direction is set at the angle of about 10 to 20 degrees to the teeth arrangement direction of the comb-like pixel electrode 26.

A seal member is applied around a display region on the TFT substrate 20 with a dispenser, and the substrates are bonded such that the oriented films 50 face each other. The sealing member is cured while heated under an appropriate pressure. In this way, the cell gap of the transmissive region is adjusted to 3.2 μm, and the cell gap of the reflective region is adjusted to 1.6 μm. Then, a liquid crystal material having a double refractive index of 0.088 (wavelength: 589.3 nm, 20° C.), for example, MLC6418 available from melc is filled in between the substrates with vacuum infusion or the like. After the injection of the liquid crystal, an injection port is sealed to complete the liquid crystal panel 1.

A circularly polarizing plate with a retarder as described in detail in the following embodiments is bonded to the outer surface of the thus-manufactured liquid crystal panel 1 on both of the TFT side and CF side. Further, a back light unit as an illuminating device is provided outside the TFT substrate to complete the liquid crystal display.

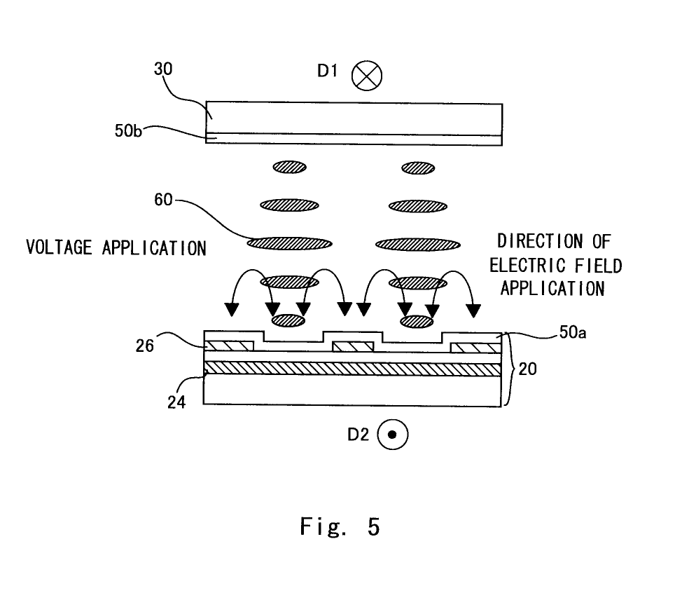

Next, movement of the liquid crystal molecules 60 of the liquid crystal panel 1 is described. FIG. 4 shows how liquid crystal molecules move under such conditions that no voltage is applied between the pixel electrode 26 and the common electrode 24, and FIG. 5 shows how liquid crystal molecules 60 move under such conditions that a voltage is applied between the pixel electrode 26 and the common electrode 24. By applying a voltage between the comb-like pixel electrode 26 and the common electrode 24, an electric field is applied to the liquid crystal molecules 60 in the direction of the arrow as shown in FIG. 5.

The pixel electrode 26 and the common electrode 24 are formed on the TFT substrate 20 including the TFT 40. The liquid crystal layer 10 is formed between the CF substrate 30 including a color filter and the TFT substrate 20. Here, description is made of a P (positive) type liquid crystal where the liquid crystal molecules 60 are aligned toward the direction parallel to the electric field application direction.

The oriented film 50 is formed between the TFT substrate 20 and the liquid crystal layer 10 and between the CF substrate 30 and the liquid crystal layer 10. An oriented film 50b of the CF substrate 30 is given orientation property in the direction D1 through rubbing. The direction D1 extends from the front side to the rear side of the figure plane. Further, the oriented film 50a of the TFT substrate 20 is given orientation property in the direction D2 through rubbing. The direction D2 extends from the rear side to the front side of the figure plane.

Thus, a liquid crystal used for the liquid crystal layer 10 is uniaxially oriented substantially in parallel to the TFT substrate 20 and the CF substrate 30 if no voltage is applied as shown in FIG. 4. Incidentally, the present invention is not limited to the above rubbing direction for the oriented film 50, but the rubbing direction may be set to a desired direction as long as the direction for the oriented film 50a of the TFT substrate 20 is opposite to that for the oriented film 50b of the CF substrate 30.

In contrast, if a voltage is applied between the comb-like pixel electrode 26 and the common electrode 24, as shown in FIG. 5, the liquid crystal molecules 60 for the liquid crystal layer 10 are oriented in a different direction, which causes torsional deformation in parallel to the TFT substrate 20 and the CF substrate 30. As a result, a polarizing direction in the liquid crystal layer 10 is changed to adjust an amount of light transmitted through the liquid crystal layer 10.

### First Embodiment

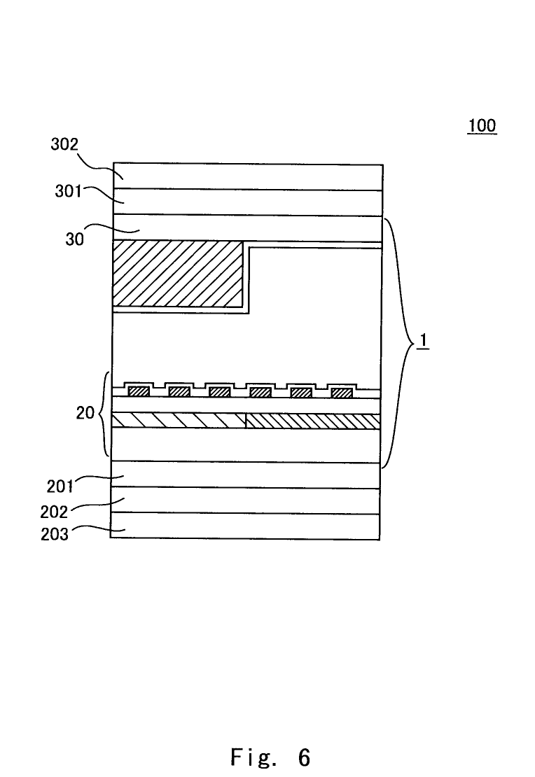

A liquid crystal display 100 according to a first embodiment of the present invention includes the TFT substrate 20 and the CF substrate 30 as two substrates sandwiching the liquid crystal layer 10 in the above liquid crystal panel 1. FIG. 6 is a sectional view of the liquid crystal display 100 of this embodiment. The CF substrate 30 is positioned on the front side and the TFT substrate 20 is positioned on the rear side. In the liquid crystal display 100, a back light unit is provided on the rear side of the TFT substrate 20.

Further, in the liquid crystal display 100 of this embodiment, a biaxial retarder 201 (first about-λ/2-wave plate) having an in-plane phase difference of about λ/2, a biaxial retarder 202 (first about-λ/4-wave plate) having an in-plane phase difference of about λ/4, and a polarizing plate 203 (first polarizing plate) are arranged on the outer surface of the TFT substrate 20 in the stated order from the TFT substrate 20 side. Further, a biaxial retarder 301 (second about-λ/4-wave plate) having an in-plane phase difference of about λ/4 and a polarizing plate 302 (second polarizing plate) are arranged on the outer surface of the CF substrate 30 in the stated order from the CF substrate 30 side. The polarizing plate is intended to absorb light oscillating in one direction and allow transmission of light oscillating in the other direction to thereby generate linearly-polarized light. As a result, it is possible to provide a liquid crystal display of wide view angle, which is free of tone reversal, in a liquid crystal mode for applying a horizontal electric field to a liquid crystal at low cost.

A circularly polarizing plate used for a general transflective liquid crystal display is a so-called wide-band circularly polarizing plate, in which a λ/4-wave plate, a λ/2-wave plate, and a polarizer are arranged in this order from a panel side opposite to the liquid crystal layer of the substrate. The present invention provides a transflective liquid crystal display, but its structure is absolutely different from general circularly polarizing plates. That is, the biaxial retarder 201 having an in-plane phase difference of about λ/2 or the biaxial retarder 301 having an in-plane phase difference of about λ/4 is directly bonded to the glass substrate. Further, the λ/4-wave plate and the λ/2-wave plate are interchanged in position on the TFT substrate 20 side. The λ/2-wave plate is not provided between λ/4-wave plate and the polarizing plate on the CF substrate 30 side.

Further, in the transflective liquid crystal device of this embodiment, biaxial retarders 202 and 301 having an in-plane phase difference of about λ/4 are provided adjacent to the inner side of the polarizers 203 and 302 (liquid crystal layer side). The biaxial retarders 202 and 301 having an in-plane phase difference of about λ/4 are arranged such that polarizing axes extend in the direction substantially parallel or substantially vertical to polarizing axes of the polarizing plates 203 and 302. This is to realize crossed nicols (orthogonality) of the polarizing plates 203 and 302 by use of the biaxial retarders 202 and 301 having an in-plane phase difference of about λ/4.

If two orthogonal polarizing plates are used, crossed nicols cannot be realized, so a black area is isolated at the view angle other than the front view angle. Further, if there is a large angular difference between the polarizing axes of the polarizing plates 203 and 302 and the polarizing axes of the biaxial retarders 202 and 301 having an in-plane phase difference of about λ/4, a phase difference occurs in the biaxial retarders 202 and 301 having an in-plane phase difference of about λ/4, which influences a design for attaining a black-and-white display in both of the transmissive mode and the reflective mode. Therefore, in the transflective liquid crystal device of this embodiment, the biaxial retarders 202 and 301 having an in-plane phase difference of about λ/4 are provided adjacent to the inner side of the polarizers 203 and 302 (liquid crystal layer side) such that polarizing axes extend in the direction substantially parallel or substantially vertical to the polarizing axes of the polarizers 203 and 302.

Further, it is preferred to use a biaxial retarder as the retarder. This is to compensate for change in light phase difference and keep a predetermined difference because an optical path length in the liquid crystal layer varies depending on view angle (light output angle).

Further, in the transflective liquid crystal device of this embodiment, the biaxial retarder 201 having an in-plane phase difference of about λ/2 is provided on the inner side of the biaxial retarder 202 having an in-plane phase difference of about λ/4 on the TFT substrate 20 side (liquid crystal layer side). The biaxial retarder 201 having an in-plane phase difference of about λ/2 is provided to attain a black-and-white display in both of the transmissive mode and the reflective mode in the horizontal electric field type device.

At this time, the odd number of biaxial retarders having an in-plane phase difference of about λ/2 should be provided. Hence, in the transflective liquid crystal device of this embodiment, a single biaxial retarder having an in-plane phase difference of about λ/2 is provided on the inner side of biaxial retarder 202 having an in-plane phase difference of about λ/4 on the TFT substrate 20 side (liquid crystal layer side). Further, to realize an in-plane phase difference of about λ/2 in a wide band, it is necessary to set the optimum axial angle of the retarder. Further, the reason the wave plate having an in-plane phase difference of about λ/2 is a biaxial retarder is to keep a phase difference of λ/2 at a given view angle.

Display characteristics of the liquid crystal display panel are determined based on phase differences in various retarders (biaxial retarders), Nz coefficients, a slow axis angle, an absorbing axis angle of the polarizing plate, cell gaps in the reflective region and the transmissive region, an axial angle of the liquid crystal layer (an angular difference between the rubbing direction of the substrate 1 and the rubbing direction of the substrate 2), and physical properties of a liquid crystal material (refractive index). Desired electro optical characteristics can be obtained by appropriately setting these parameters. The Nz coefficient is a value defined by Nz=(nₓ−n_{z})/(nₓ−n_{y}). The refractive index in the slow axis direction in the retarder plane is represented by nₓ, the refractive index in the direction orthogonal to nₓ in the retarder plane is represented by n_{y}, and the refractive index in the vertical direction of the retarder is represented by n_{z}.

Values of the above parameters that contribute to optical design of this embodiment are summarized in Table 1 below. A retardation of the retarder is calculated based on the wavelength of 550 nm, and the retardation of a liquid crystal is calculated based on the wavelength of 589.3 nm.

TABLE 1

| | | IN-PLANE | SLOW AXIS |
|---|---|---|---|
| | | PHASE | OR |
| | | DIFFERENCE, | ABSORBING |
| | | Nz | AXIS |
| CF SUBSTRATE | POLARIZER | — | 145° |
| SIDE | BIAXIAL | 130 nm, Nz = 0.4 | 146° |
| | RETARDER | | |
| LIQUID QRYSTAL | | 280 nm | 100.5° |
| (TRANSMISSIVE) | | | |
| LIQUID QRYSTAL | | 140 nm | 100.5° |
| (REFLECTIVE) | | | |
| TFT SUBSTRATE | BIAXIAL | 270 nm, Nz = 0.5 | 10° |
| SIDE | RETARDER | | |
| | BIAXIAL | 130 nm, Nz = 0.4 | 55° |
| | RETARDER | | |
| | POLARIZER | — | 57° |

The axial angle is increased (+) in the counterclockwise direction with the right direction (3 o'clock direction) set to reference angle (0 degrees). That is, the 3 o'clock direction is set to 0°, the 12 o'clock direction is set to 90°, the 9 o'clock direction is set to 180°, and the 6 o'clock direction is set to 270°. The biaxial retarder is available from Nitto Denko Corporation, and the Nz coefficient is not limited to 0.4 or 0.5 as shown in Table 1 but may be selected from a range of 0 to 0.8.

Further, an adhesive for bonding the circularly polarizing plate (laminate of the polarizer 302 and the λ/4-wave plate 301) on the CF substrate 30 side and the glass substrate or an adhesive for bonding the polarizer 302 in the circularly polarizing plate on the CF substrate 30 side and the λ/4-wave plate 301 may be a disp. adhesive. In particular, the disp. adhesive is preferably used for bonding the glass substrate and the circularly polarizing plate. This is because, at the time of reflecting light incident on the liquid crystal panel, light reflected in one direction can diffuse in all directions due to the disp. adhesive.

As a result, the visibility in the reflective mode can be improved. To reflect light incident on the liquid crystal panel 1, the reflective electrode 23 is formed on the TFT substrate 20 in the liquid crystal panel 1. Further, a mirror reflector may be provided on the rear side of the liquid crystal panel 1 in place of the reflective electrode 23. That is, light reflected by the reflective electrode 23 or mirror reflector can diffuse with the disp. adhesive. The disp. adhesive is obtained by randomly mixing beads having a refractive index different from that of an adhesive into the adhesive, and thus has a function of diffusing transmitted light. As the disp. adhesive, for example, haze 60 is used.

Further, an anti-reflection film may be formed through evaporation or continuous sputtering on the circularly polarizing plate on the CF substrate 30 side. Hence, display quality of the liquid crystal display in the reflective mode can be further increased.

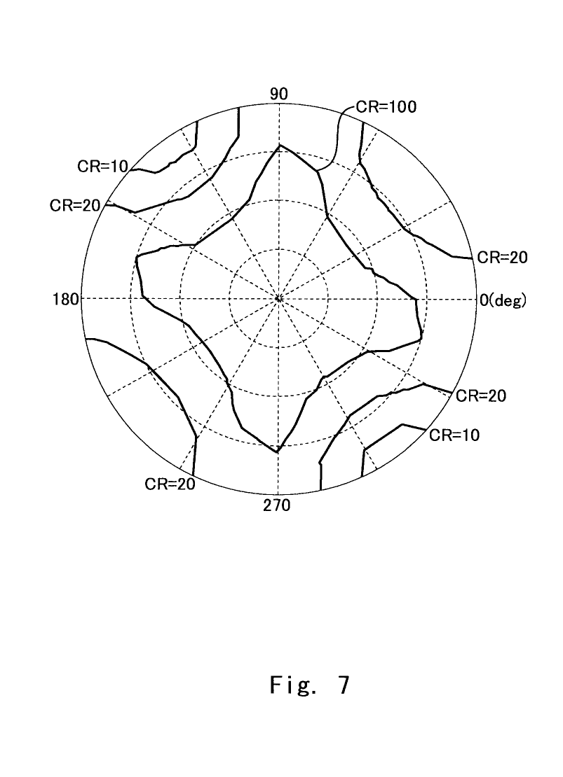

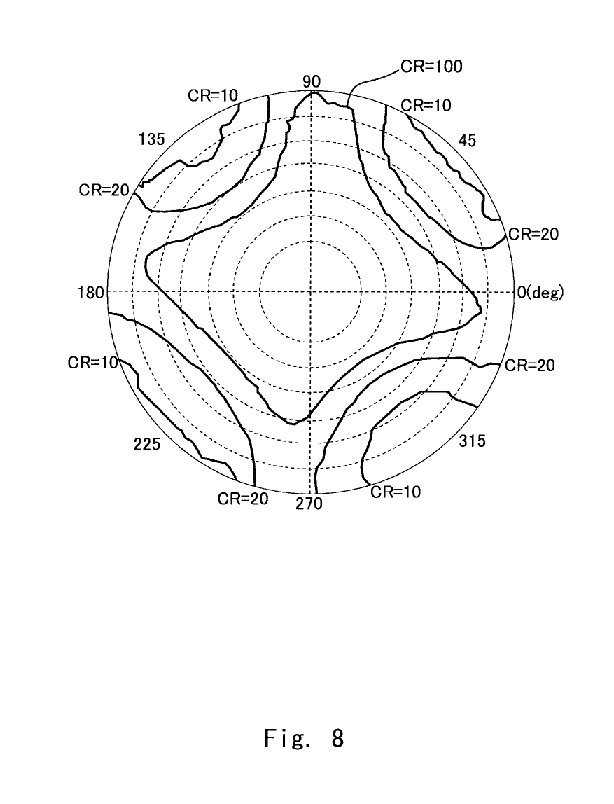

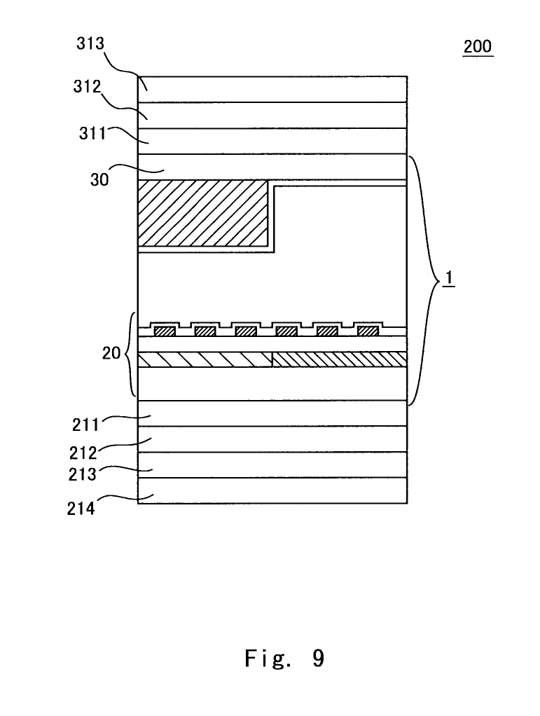

FIGS. 7 and 8 show calculated values and actual measurement values on an iso CR curve that represents view angle characteristics in the transmissive mode of the liquid crystal display manufactured through the above processes. The actual measurement result substantially matches with values estimated by calculation; CR>10 is realized at the angle of ±80 degrees in the left, right, top and bottom of directions and the front CR of 300 or more is also realized.

As described above, in the liquid crystal display of this embodiment, the above-described phase difference film and polarizer are provided on the outer side of the liquid crystal panel. Thus, it is possible to provide a liquid crystal display capable of transmissive display at wide view angle and black-and-white display in both of the transmissive mode and the reflective mode without involving tone reversal at low cost. Hence, display quality can be improved.

### Second Embodiment

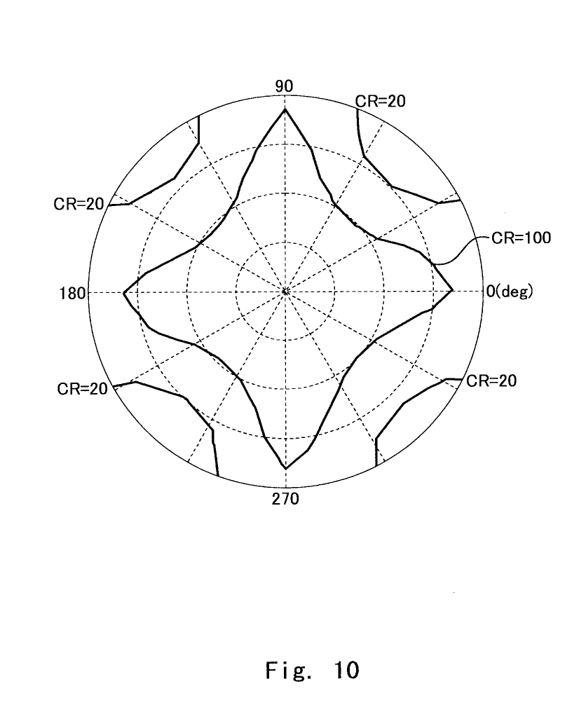

FIG. 9 is a sectional view of a liquid crystal display 200 according to a second embodiment of the present invention. The liquid crystal display 200 of this embodiment includes the TFT substrate 20 and the CF substrate 30 as two substrates sandwiching the liquid crystal layer 10 of the above liquid crystal panel 1. The CF substrate 30 is positioned on the front side, and the TFT substrate 20 is positioned on the rear side. In the liquid crystal display 200, a back light unit is provided on the rear side of the TFT substrate. The same components and operational principle as those of the first embodiment are omitted here.

Further, in the liquid crystal display 200 of this embodiment, a biaxial retarder 211 having an in-plane phase difference of about λ/2 (first about-λ/2-wave plate), an biaxial retarder 212 having an in-plane phase difference of about λ/2 (second about-λ/2-wave plate), a biaxial retarder 213 having an in-plane phase difference of about λ/4 (first about-λ/4-wave plate), and a polarizing plate 214 (first polarizing plate) are provided on the outer surface of the TFT substrate 20 in this order from the TFT substrate 20 side. Further, a biaxial retarder 311 having an in-plane phase difference of about λ/2 (third about-λ/2-wave plate), a biaxial retarder 312 having an in-plane phase difference of about λ/4 (second about-λ/4-wave plate) and a polarizing plate 313 (second polarizing plate) are provided on the outer surface of the CF substrate 30 in this order from the CF substrate 30 side. In this way, it is possible to provide a liquid crystal display of wide view angle at low costs in the liquid crystal mode for applying a horizontal electric field to the liquid crystal without involving tone reversal. This is because a single biaxial retarder having an in-plane phase difference of about λ/2 is provided on the TFT substrate 20 side and the CF substrate 30 side to keep a phase difference of λ/2 at wider view angle.

Values of the above parameters that contribute to optical design of the second embodiment are summarized in Table 2. The retardation of the retarder is calculated based on the wavelength of 550 nm, and the retardation of the liquid crystal is calculated based on the wavelength of 589.3 nm.

TABLE 2

| | | IN-PLANE | SLOW AXIS |
|---|---|---|---|
| | | PHASE | OR |
| | | DIFFERENCE, | ABSORBING |
| | | Nz | AXIS |
| CF SUBSTRATE | POLARIZER | — | 75° |
| SIDE | BIAXIAL | 140 nm, Nz = 0.3 | 165° |
| | RETARDER | | |
| | BIAXIAL | 270 nm, Nz = 0.3 | 97.5° |
| | RETARDER | | |
| LIQUID QRYSTAL | | 270 nm | 85° |
| (TRANSMISSIVE) | | | |
| LIQUID QRYSTAL | | 135 nm | 85° |
| (REFLECTIVE) | | | |
| TFT SUBSTRATE | BIAXIAL | 270 nm, Nz = 0.3 | 165° |
| SIDE | RETARDER | | |
| | BIAXIAL | 270 nm, Nz = 0.3 | 7.5° |
| | RETARDER | | |
| | BIAXIAL | 140 nm, Nz = 0.3 | 165° |
| | RETARDER | | |
| | POLARIZER | — | 165° |

The axial angle is increased (+) in the counterclockwise direction with the right direction (3 o'clock direction) set to reference angle (0 degrees). That is, the 3 o'clock direction is set to 0°, the 12 o'clock direction is set to 90°, the 9 o'clock direction is set to 180°, and the 6 o'clock direction is set to 270°. The biaxial retarder is available from Nitto Denko Corporation, and the Nz coefficient is not limited to 0.4 or 0.5 as shown in Table 1 but may be selected from a range of 0 to 0.8.

FIG. 10 show calculated values and actual measurement values on an iso CR curve that represents view angle characteristics in the transmissive mode of the liquid crystal display manufactured through the above processes. As shown in FIG. 10, CR of 10 or more is realized in all directions. That is, the liquid crystal display of the present invention can realize transmissive display at wide view angle and black-and-white display in both of the transmissive mode and the reflective mode without involving tone reversal at low cost. Hence, display quality can be improved.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A horizontal electric field type liquid crystal display, comprising:
a first substrate;
a second substrate opposite to the first substrate;
a liquid crystal layer sandwiched between the first substrate and the second substrate;
pixels arranged in matrix and including a transmissive region and a reflective region;
a pixel electrode and a common electrode provided on the first substrate and applying a voltage to the liquid crystal layer;
a first about-λ/2-wave plate provided on the opposite side of the liquid crystal layer in the first substrate;
a first about-λ/4-wave plate provided on the opposite side of the liquid crystal layer in the first about-λ/2-wave plate;
a first polarizing plate provided on the opposite side of the liquid crystal layer in the first about-λ/4-wave plate;
a second about-λ/4-wave plate provided on the opposite side of the liquid crystal layer in the second substrate; and
a second polarizing plate provided on the opposite side of the liquid crystal layer in the second about-λ/4-wave plate.

2. A horizontal electric field type liquid crystal display, comprising:
a first substrate;
a second substrate opposite to the first substrate;
a liquid crystal layer sandwiched between the first substrate and the second substrate;
pixels arranged in matrix and including a transmissive region and a reflective region;
a pixel electrode and a common electrode provided on the first substrate and applying a voltage to the liquid crystal layer;
a first about-λ/2-wave plate provided on the opposite side of the liquid crystal layer in the first substrate;
a second about-λ/2-wave plate provided on the opposite side of the liquid crystal layer in the first about-λ/2-wave plate;
a first about-λ/4-wave plate provided on the opposite side of the liquid crystal layer in the second about-λ/2-wave plate;
a first polarizing plate provided on the opposite side of the liquid crystal layer in the first about-λ/4-wave plate;
a third about-λ/2-wave plate provided on the opposite side of the liquid crystal layer in the second substrate;
a second about-λ/4-wave plate provided on the opposite side of the liquid crystal layer in the third about-λ/2-wave plate; and
a second polarizing plate provided on the opposite side of the liquid crystal layer in the second about-λ/4-wave plate.

3. The liquid crystal display according to claim 1, wherein a dispersion adhesive is provided closer to the liquid crystal layer than the second about-λ/4-wave plate on the opposite side of the liquid crystal layer in the second substrate.

4. The liquid crystal display according to claim 2, wherein a dispersion adhesive is provided closer to the liquid crystal layer than the second about-λ/4-wave plate on the opposite side of the liquid crystal layer in the second substrate.

5. The liquid crystal display according to claim 1, wherein an anti-reflection film is formed on the second polarizing plate.

6. The liquid crystal display according to claim 2, wherein an anti-reflection film is formed on the second polarizing plate.

7. The liquid crystal display according to claim 3, wherein an anti-reflection film is formed on the second polarizing plate.

8. The liquid crystal display according to claim 4, wherein an anti-reflection film is formed on the second polarizing plate.

9. The liquid crystal display according to claim 1, wherein at least one of the first about-λ/2-wave plate, the first about-λ/4-wave plate,and the second about-λ/4-wave plate is a biaxial retarder having a Nz coefficient in a range of 0 to 0.8.

10. The liquid crystal display according to claim 2, wherein at least one of the first about-λ/2-wave plate, the second about-λ/2-wave plate, the first about-λ/4-wave plate, the third about-λ/2-wave plate, and the second about-λ/4-wave plate is a biaxial retarder having a Nz coefficient in a range of 0 to 0.8.

11. The liquid crystal display according to claim 3, wherein the second about-λ/4-wave plate is a biaxial retarder having a Nz coefficient in a range of 0 to 0.8.

12. The liquid crystal display according to claim 4, wherein the second about-λ/4-wave plate is a biaxial retarder having a Nz coefficient in a range of 0 to 0.8.
